(19) United States
(12) Patent Application Publication
(10) Pub. No.: US 2011/0076514 A1
(43) Pub. Date: Mar. 31, 2011

(54) MAGNETIC RECORDING MEDIUM

(75) Inventor: Noboru KURATA, Matsumoto City (JP)

(73) Assignee: Fuji Electric Device Technology Co., Ltd., Tokyo (JP)

(21) Appl. No.: 12/831,622

(22) Filed: Jul. 7, 2010

(30) Foreign Application Priority Data
Sep. 30, 2009 (JP) 2009-226735

(51) Int. Cl. G11B 5/00

(52) U.S. Cl. 428/800

(57) ABSTRACT

A magnetic recording medium includes a substrate; a magnetic recording layer that is provided on the substrate and that has a plurality of tracks; and a separation layer that magnetically separates respective tracks of the plurality of tracks of the magnetic recording layer from one another and that is composed of a material including a nonmagnetic amorphous alloy selected from the group consisting of chromium boride (CrB), nickel boride (NiB), chromium phosphide (CrP), and nickel phosphide (NiP). The nonmagnetic amorphous alloy is used as a filler material for the separation layer and has a smooth surface after filling and an excellent corrosion resistance. This enables production of the magnetic recording medium by a simple method so that producibility is excellent and without spoiling reliability.

### CROSS-REFERENCE TO RELATED APPLICATION

This non-provisional Application claims the benefit of the priority of Applicant's earlier filed Japanese Patent Application Laid-open No. 2009-226735 filed Sep. 30, 2009, the entire contents of which are incorporated herein by reference.

### BACKGROUND OF THE INVENTION

1. Field of the Invention

The present invention relates to a magnetic recording medium which has a good electromagnetic transducing characteristic as a high recording density perpendicular magnetic recording medium, which is suitable as a discrete track medium or a patterned medium, and which has excellent producibility.

2. Description of the Background Art

A magnetic recording apparatus is one of the information recording apparatuses which support our recent advanced information society. With the increase in the quantity of information, improvement in recording density is required of a magnetic recording medium used in a magnetic recording apparatus. To achieve high recording density, a magnetization reversal unit must be reduced. For this reason, it is important that magnetic grain size is reduced to a fine grain size and, at the same time, the magnetization reversal units are separated and partitioned so as to markedly reduce magnetic interaction between adjacent recording units.

A discrete track medium (DTM) has attracted public attention as a technique for achieving high density magnetic recording. In the DTM, a separation layer of a nonmagnetic material is provided between adjacent tracks of a magnetic recording layer to thereby reduce magnetic interference between the adjacent tracks. By clearly partitioning the magnetic reversal units, that is, by producing a file of magnetic material that is magnetically completely cut between neighboring tracks, and by obtaining a boundary between adjacent tracks artificially, write blur of adjacent tracks and formation of zigzag magnetic walls can be eliminated.

To produce a conventional DTM, for example, as described in JP-A-2006-31849 and JP-A-2005-243131, a mask of predetermined recording tracks is formed on a continuous magnetic layer for forming a separated magnetic recording layer in each recording track, and concave portions are provided for separating the magnetic layer by etching. A technique for embedding a nonmagnetic material (separation layer) in each concave portion to obtain flatness and forming a protective layer thereon has been proposed for the purpose of improving floating stability and enhancing reliability. A silicon oxide compound represented by SiO₂ or Spin On Glass (SOG) has been proposed as the nonmagnetic material.

JP-A-2005-243131 has described that a nonmagnetic material having an amorphous structure is used as the nonmagnetic material with which each concave portion is filled as the separation layer.

However, the method of filling SOG or the like with separation portions between the tracks of the magnetic layer (magnetic recording layer) and forming the protective film thereon has several issues.

Firstly, because the expansion coefficient difference between the magnetic material of the magnetic layer and the filler material such as SOG is large, stress acts on the protective film to increase defects when the magnetic recording medium is left in an environment in which temperature change occurs. Therefore, the magnetic recording medium is disadvantageously apt to be corroded.

Moreover, because smoothness is insufficient and the filler layer (separation layer) located on the magnetic layer need be removed after each concave portion is filled with the aforementioned material, a flattening process such as dry etching, CMP, etc. is required. On this occasion, cutting the filler layer up to the magnetic layer surface is preferable but difficult for mass production. For this reason, over-etching is predicted while roughness occurs on this occasion because of the etching rate difference between the separation layer and the magnetic layer.

As a solution to such an issue, it can be conceived that the separation layer be filled with a nonmagnetic metal having an expansion coefficient close to that of the magnetic layer. Although it can be conceived that the separation layer may be filed with chromium, titanium or the like by sputtering in consideration of corrosion resistance and economical efficiency, there is the disadvantage that surface roughness becomes large when the separation layer is formed.

Because the depth (i.e., the difference of the levels between concave and convex portions) of each concave portion filled with a nonmagnetic metal as the separation layer is in a range of from several nm to on the order of tens of nm, the thickness of the filler layer needs a range of from several nm to on the order of tens of nm. However, the surface roughness Rmax (maximum height) of a metal such as chromium or titanium reaches about several nm even when the thickness of the metal film is about 20 nm. Disadvantageous surface roughening occurs.

Although it can be conceived that dry etching, CMP or the like is used as the flattening process after that, it is difficult to control uniformity and the like in the latter CMP and the latter CMP is not preferred from the viewpoint of cost because a cleaning process is required.

For this reason, it is preferable that flattening is performed by dry etching but it is difficult to make smooth the once roughened surface on this occasion. In addition, it is important that the surface is not roughened while dry etching is performed. This is because head floating characteristic is worsened when the surface is roughened.

Accordingly, a separation layer substantially the same in linear expansion coefficient as the magnetic material of the magnetic layer and excellent in smoothness is required. In addition, a separation layer portion having the same etching rate as that of the magnetic layer portion of each track portion is required.

The invention is accomplished in consideration of such circumstances. An object of the invention thus is to provide a magnetic recording medium that can be produced by a simple method without spoiling reliability and that is excellent in producibility, by providing a nonmagnetic metal having a smooth surface after filling and having excellent corrosion resistance, for the filler material of a separation layer aimed for magnetically separating tracks of a magnetic recording layer from one another.

### SUMMARY OF THE INVENTION

To achieve the foregoing object, the invention provides a magnetic recording medium including a substrate; at least a magnetic recording layer that is provided on the substrate and that has a plurality of tracks; and a separation layer that magnetically separates respective tracks of the plurality of tracks of the magnetic recording layer from one another and that is made of a nonmagnetic amorphous alloy selected from the group consisting of chromium boride (CrB), nickel boride (NiB), chromium phosphide (CrP), and nickel phosphide (NiP). The separation layer may comprise the nonmagnetic amorphous alloy. The separation layer may consist essentially of the nonmagnetic amorphous alloy. The separation layer may consist of the nonmagnetic amorphous alloy.

When the nonmagnetic amorphous alloy is chromium boride (CrB), it is preferable that CrB contains 5 atomic % to 20 atomic % of boron (B). When the nonmagnetic amorphous alloy is nickel boride (NiB), it is preferable that NiB contains 12 atomic % to 22 atomic % of boron (B). When the nonmagnetic amorphous alloy is chromium phosphide (CrP), it is preferable that CrP contains 8 atomic % to 18 atomic % of phosphorus (P). When the nonmagnetic amorphous alloy is nickel phosphide (NiP), it is preferable that NiP contains 14 atomic % to 24 atomic % of phosphorus (P). It is preferable that the magnetic recording medium further includes a protective layer provided on the magnetic recording layer.

According to the invention, a nonmagnetic amorphous alloy excellent in corrosion resistance and selected from the group consisting of chromium boride (CrB), nickel boride (NiB), chromium phosphide (CrP) and nickel phosphide (NiP) is used as a filler material of a separation layer for magnetically separating tracks of a magnetic recording layer from one another so that a smooth surface can be provided after filling. Accordingly, a magnetic recording medium can be produced as a discrete track medium or a patterned medium by a simple method so that producibility is excellent and without spoiling reliability.

### BRIEF DESCRIPTION OF THE DRAWINGS

FIG. 1 is a schematic sectional view showing a magnetic recording medium according to an embodiment of the invention;

FIGS. 2A to 2G are schematic diagrams showing a process for producing the magnetic recording medium according to an embodiment of the invention;

FIG. 3 is a graph showing B concentration dependence of surface roughness, Ra, after formation of a Cr—B alloy film used as a separation layer and after etching;

FIG. 4 is a graph showing B concentration dependence of surface roughness, Ra, after formation of an Ni—B alloy film used as a separation layer and after etching;

FIG. 5 is a graph showing P concentration dependence of surface roughness, Ra, after formation of a Cr—P alloy film used as a separation layer and after etching; and

FIG. 6 is a graph showing P concentration dependence of surface roughness, Ra, after formation of an Ni—P alloy film used as a separation layer and after etching.

### DETAILED DESCRIPTION OF THE INVENTION

An embodiment of the invention will be described below with reference to the drawings. Incidentally, in the drawings, the same or identical parts are referred to by the same numerals in order to minimize descriptive duplication.

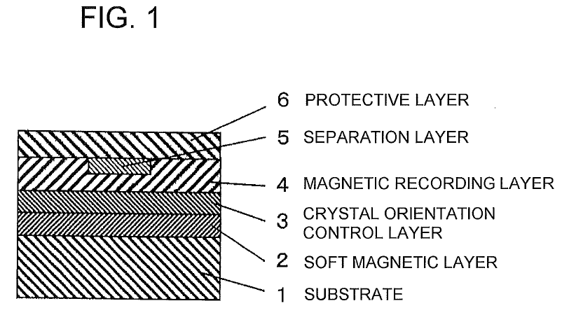

FIG. 1 is a schematic sectional view showing a magnetic recording medium according to an embodiment of the invention. The magnetic recording medium according to this embodiment is configured so that a soft magnetic layer 2, a crystal orientation control layer 3, a magnetic recording layer 4 and a protective layer 6 are provided in this order on a substrate 1 which is a nonmagnetic substrate. The magnetic recording layer 4 is magnetically separated into recording tracks by the separation layer 5.

The magnetic recording layer 4 can be provided as a laminated structure (not shown). In this embodiment, the magnetic recording layer 4 is composed of a first magnetic recording layer having a granular structure and a second magnetic recording layer having a non-granular structure formed on the first magnetic recording layer.

The separation layer 5 is made of a nonmagnetic amorphous alloy selected from the group consisting of chromium boride (CrB), nickel boride (NiB), chromium phosphide (CrP), and nickel phosphide (NiP).

When the nonmagnetic amorphous alloy which forms the separation layer 5 is chromium boride (CrB), it is preferable that CrB contains 5 atomic % to 20 atomic % of boron (B). When the nonmagnetic amorphous alloy is nickel boride (NiB), it is preferable that NiB contains 12 atomic % to 22 atomic % of boron (B). When the nonmagnetic amorphous alloy is chromium phosphide (CrP), it is preferable that CrP contains 8 atomic % to 18 atomic % of phosphorus (P). When the nonmagnetic amorphous alloy is nickel phosphide (NiP), it is preferable that NiP contains 14 atomic % to 24 atomic % of phosphorus (P).

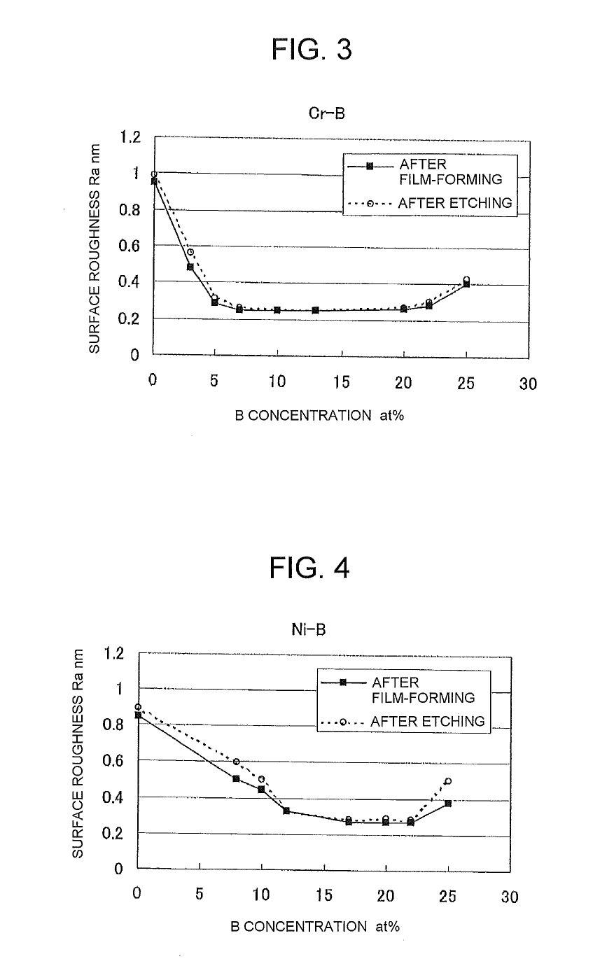

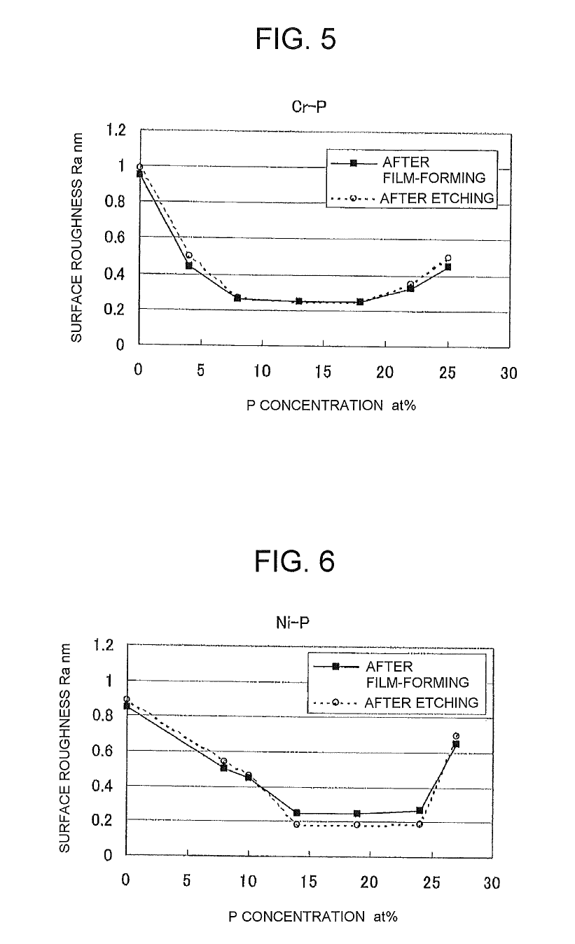

The separation layer 5 can be formed by a sputtering method. When the B or P content is in the aforementioned ranges, the separation layer 5 is amorphous and excellent in smoothness as shown in FIGS. 3 to 6 because surface roughness after formation of a nonmagnetic amorphous alloy film is smaller than that of a single metal.

FIGS. 3 to 6 show composition dependence of surface roughness, Ra, after formation of a nonmagnetic amorphous alloy film as the separation layer 5. The composition dependence of surface roughness, Ra, is expressed in a value which is obtained when a 20 nm-thick film formed of each material on a smooth silicon wafer of Ra 0.25 nm by a sputtering method is measured with an AFM (Atomic Force Microscope).

Even when the film is etched, surface roughness changes little as long as the B or P content is in the aforementioned range. That is, smoothness can be kept as shown in FIGS. 3 to 6.

FIGS. 3 to 6 also show composition dependence of surface roughness, Ra, after the film of the aforementioned composition was etched for 10 seconds by an ion milling method. As the conditions on this occasion, the flow rate of argon gas, gas pressure and power were set to be 50 sccm, 5 Pa and 250 W, respectively.

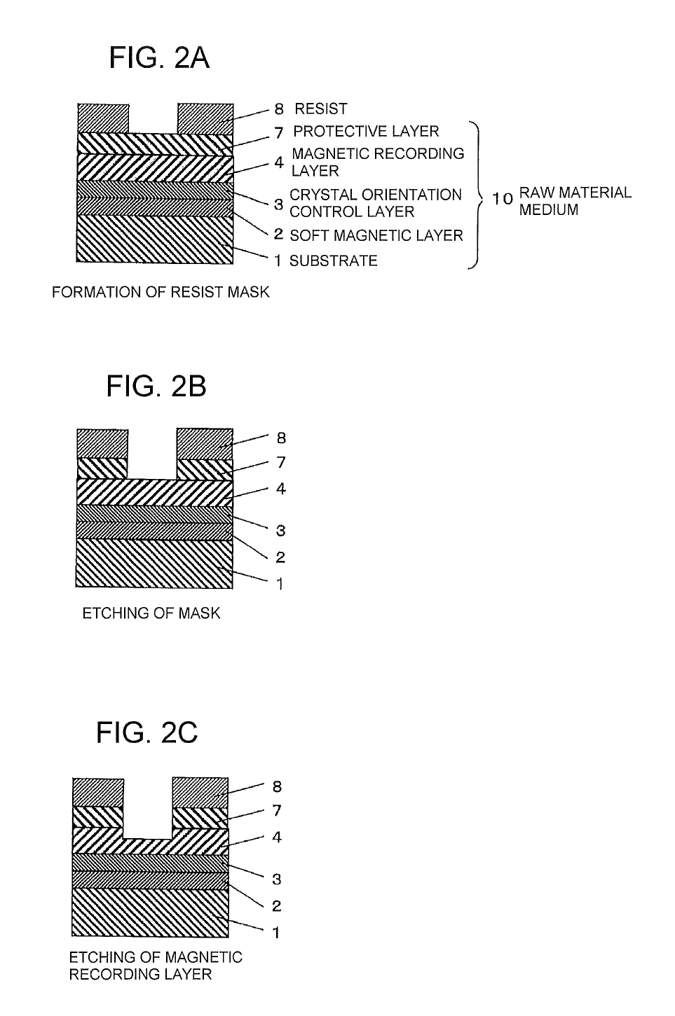

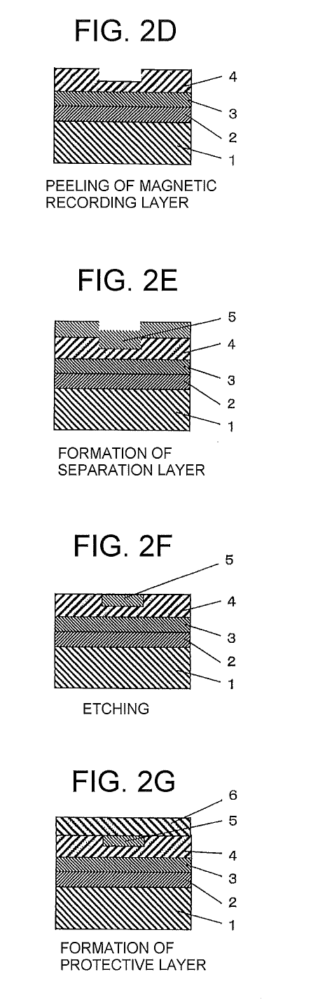

The magnetic recording medium according to this embodiment can be produced by a production process schematically shown in FIGS. 2A to 2G.

After a soft magnetic layer 2, a crystal orientation control layer 3 and a magnetic recording layer (magnetic layer) 4 are formed successively on a substrate 1 by sputtering, a protective layer (protective film) 7 is formed. Thus, a raw material medium 10 is produced.

Then, the raw material medium 10 is processed as shown in FIGS. 2A to 2F to thereby form a separation layer 5.

That is, as shown in FIG. 2A, a resist 8 patterned into a predetermined form is formed. Although this patterning can be performed by an imprinting method, an EB drawing apparatus, etc., the invention is not limited thereto. When an imprinting method is used, Spin On Glass (SOG) or the like is used as the resist 8.

Then, as shown in FIG. 2B, the protective film 7 is etched. The etching is performed by ion milling or oxygen plasma. Further, as shown in FIG. 2C, the magnetic layer 4 is processed up to a predetermined depth by ion milling or the like to thereby form a separation portion (concave portion).

Then, as shown in FIG. 2D, the resist 8 and the protective film 7 are peeled. When a silicon oxygen compound such as SOG is used, the peeling can be performed by plasma processing with a corrosive gas such as CF₄ gas. When a reactive ion etching method using CF₄ gas as a reactive gas is used, the peeling can be performed by a high density plasma etching apparatus using an Inductive Coupled Plasma (ICP) method. As the kind of gas, another gas other than CF₄ gas can be used as long as the gas contains halogen. For example, a gas of CHF₃, CH₂F₂, C₃F₈, C₄F₈, SF₆, Cl₂, or the like can be used. When the resist 8 is an ordinary resist, this peeling can be performed by an organic solvent, oxygen plasma or the like.

On this occasion, the recording track portion is not corroded because of the presence of the protective film 7. Then, the protective film 7 is removed up to the surface of the magnetic layer 4 by ion milling, oxygen plasma or the like. On this occasion, just etching is performed to minimize damage of the recording tracks. Alternatively, the protective film 7 may be left in place as long as the remaining thickness of the protective film 7 is several nm. It is preferable that an end point monitor or the like is used for this etching.

Then, as shown in FIG. 2E, a separation layer 5 is formed. Any one of a chromium alloy containing 5 atomic % to 20 atomic % of boron, a nickel alloy containing 12 atomic % to 22 atomic % of boron, a chromium alloy containing 8 atomic % to 18 atomic % of phosphorus and a nickel alloy containing 14 atomic % to 24 atomic % of phosphorus is selected to form the separation layer 5 by a sputtering method. It is preferable that the film thickness of the separation layer 5 is from one to ten times as large as the depth of the separation layer.

Then, as shown in FIG. 2F, a surplus of the separation layer is removed by etching. Argon ion milling or the like is used for etching. On this occasion, it is preferable that the separation layer is flat, but a difference in level of about several nm is allowable. Alternatively, a process of forming a separation layer and etching the separation layer may be repeated to obtain a predetermined flatness because the flatness can be improved by the repetition of the process. It is preferable that an end point monitor or the like is used for etching in order to remove only the separation layer.

Then, as shown in FIG. 2G, a protective layer (protective film) 6 is formed. On this occasion, a method such as sputtering, CVD (Chemical Vapor Deposition), etc. can be used or both sputtering and CVD may be combined. Incidentally, it is preferable that the thickness of the protective layer 6 is not larger than 5 nm in order to reduce a spacing loss between the magnetic head and the magnetic recording layer 4. Finally, a liquid lubricant is applied to complete the magnetic recording medium.

Materials or the like used for the raw material medium 10 are as follows. NiP-plated Al alloy, reinforced glass, crystallized glass or the like used for an ordinary magnetic recording medium can be used for the substrate 1.

The soft magnetic layer 2 is provided for concentrating magnetic flux generated by the magnetic head to form a steep magnetic field gradient in the magnetic recording layer 4. Although NiFe-based alloy, sendust (FeSiAl) alloy or the like can be used for the soft magnetic layer 2, a good electromagnetic transducing characteristic can be obtained when non-crystalline Co alloy, such as CoNbZr, CoTaZr, etc., is used for the soft magnetic layer 2. Although the optimum value of the film thickness of the soft magnetic layer 2 depends on the structure and characteristic of the magnetic head used for magnetic recording, it is preferable from the viewpoint of producibility that the thickness of the soft magnetic layer 2 is in a range of from 10 nm to 300 nm, both inclusively.

The crystal orientation control layer 3 is provided for suitably controlling the crystal orientation, crystal grain size and grain boundary segregation of the magnetic recording layer 4. To control the crystal orientation of the magnetic recording layer 4 suitably, it is particularly preferable that a surface of the crystal orientation control layer 3 on a side facing the magnetic recording layer 4 is made of Ru or an Ru-containing alloy having an hcp crystal structure, and that Ru crystals separated from one another are separated so that magnetic crystals of the magnetic recording layer to grow on the Ru crystals can grow while separated individually without connection to adjacent magnetic crystals.

When Ru or an Ru-containing alloy is used for forming the crystal orientation control layer 3, Ru crystals grow with a grain boundary. That is, a large number of Ru crystals grow perpendicularly, that is, from a side facing the soft magnetic layer 2 toward a side facing the magnetic recording layer 4. The width of the Ru crystals gradually decreases from the side facing the soft magnetic layer 2 toward the side facing the magnetic recording layer 4, and the distance between the Ru crystals and adjacent crystals gradually increases.

When the magnetic recording layer 4 is formed on the crystal orientation control layer 3, magnetic crystals grow on the Ru crystals respectively. When the layer of Ru or an Ru-containing alloy (hereinafter referred to as “Ru layer”) has a proper thickness, Ru crystals are formed on the magnetic recording layer side surface of the Ru layer so that a proper distance is formed between the Ru crystals and adjacent Ru crystals. When the first magnetic recording layer is formed on the crystal orientation control layer 3 having such a configuration, magnetic crystal grains oriented perpendicularly are formed on the Ru crystals, and a non-magnetic substance such as oxide or nitride is formed around the magnetic crystal grains, so that a magnetic recording layer of a granular structure (hereinafter referred to as “granular magnetic recording layer”) is formed.

When the thickness of the Ru layer is reduced from the described proper thickness, the width between adjacent Ru crystals on the magnetic recording layer side surface of the Ru layer is reduced so that adjacent magnetic crystals formed on the Ru crystals adhere to one another so as to be integrated to prevent granular crystals from being formed. On the other hand, when the Ru layer is too thick, separation of Ru crystals advances but the proportion of the grain boundary layer becomes so high that magnetic characteristic is apt to be lowered.

Although the film thickness of the crystal orientation control layer 3 allowing granular crystals to be formed varies according to a difference based on whether the crystal orientation control layer 3 is made of Ru singly or made of an Ru alloy, according to the composition of the Ru alloy and according to the granular crystal grain size and the thickness of the surrounding nonmagnetic grain boundary of the magnetic recording layer 4 to be formed on the crystal orientation control layer 3, it is preferable that the optimum value of the film thickness of the crystal orientation control layer 3 is controlled to be in a range of from 5 nm to 50 nm, both inclusively.

Separation portions are provided in at least part regions of the first magnetic recording layer. That is, when the magnetic recording medium is a discrete track medium, separation portions are provided in portions for partitioning recording tracks of recording track regions and portions for partitioning patterns of servo signal recording regions. When the magnetic recording medium is a patterned medium, separation portions are provided in portions for partitioning patterns corresponding to bits. The arrangement of the separation portions varies according to recording density. For example, recording tracks of a discrete track medium with an areal density of 500 Gbit/inch² are arranged at intervals of a pitch of 60 nm.

The first magnetic recording layer is a magnetic recording layer having a granular structure. A CoCr-based alloy is preferably used as a material for forming crystal grains having ferromagnetism of the granular magnetic recording layer having such a structure. It is particularly preferable that at least one element selected from Pt, Ni, Ta and B is added to the CoCr alloy to obtain excellent magnetic and recording/reproducing characteristics. It is preferable that oxide of at least one element selected from Si, Al, Ti, Ta, Hf and Zr is used as a material for forming the nonmagnetic grain boundary of the granular magnetic recording layer in order to form a stable granular structure.

It is preferable that the film thickness of the first magnetic recording layer is in a range of from 5 nm to 60 nm, both inclusively. This is because of the following reasons. That is, if the film thickness of the first magnetic recording layer is smaller than 5 nm, a sufficient signal characteristic as the magnetic recording layer cannot be obtained. It is necessary that the film thickness of the first magnetic recording layer is not larger than 60 nm in order to improve ease of magnetic recording and recording/reproducing resolving power. It is more preferable from the viewpoint of producibility and high density recording that the film thickness of the first magnetic recording layer is in a range of from 10 nm to 30 nm, both inclusively.

The second magnetic recording layer is formed on the first magnetic recording layer. On this occasion, the second magnetic recording layer is a magnetic recording layer having a non-granular structure (hereinafter referred to as “non-granular magnetic recording layer”) which does not contain metal oxide or metal nitride in a nonmagnetic grain boundary. The non-granular magnetic recording layer secures high durability of the medium by blocking Co atoms eluted from the nonmagnetic grain boundary of the granular magnetic recording layer located under the non-granular magnetic recording layer. It is therefore necessary that the non-granular magnetic recording layer is provided as a continuous film (solid film).

To obtain excellent magnetic and recording/reproducing characteristics, it is preferable that the non-granular magnetic recording layer is made of an alloy prepared by adding at least one element selected from Pt, Ni, Ta and B to a CoCr alloy. To secure high durability of the medium, it is preferable that the film thickness of the non-granular magnetic recording layer is in a range of from 2 nm to 20 nm, both inclusively.

A heretofore generally used protective film, such as a protective film containing carbon, ZrO₂, SiO₂ or the like as a main component, can be used as the protective layer 6. It is preferable that the film thickness of the protective layer 6 is in a range of from 1 nm to 10 nm, both inclusively. If the thickness is smaller than 1 nm, pinholes are generated or durability is worsened undesirably. If the thickness is larger than 10 nm, the distance between the magnetic recording layer and the head becomes so large that the magnetic signal read by the head becomes too small undesirably.

### EXAMPLE

An example of the invention will be described below. The following example is simply one instance for describing the invention suitably without any intention of limiting the invention at all. Although this example will be described in the case where the magnetic recording medium is a discrete track medium, the configuration of the invention can be produced by the same process even when the magnetic recording medium is a patterned medium.

### Example 1

The example will be described along the production process schematically shown in FIGS. 2A to 2G.

First, a raw material medium 10 is produced.

A chemical reinforced glass substrate (e.g., a N-5 glass substrate made by HOYA Corporation) having a smooth surface was used as a substrate 1. By a sputtering film-forming method, a 200 nm-thick soft magnetic layer 2 made of CoZrNb was formed, a 3 nm-thick NiFeNb film was formed as a crystal orientation control layer 3, and a 14 nm-thick Ru film was formed thereon. Further, a 10 nm-thick film of a CoCrPt—SiO₂ material was further formed as a first magnetic recording layer, so that a granular magnetic recording layer having a nonmagnetic grain boundary made of SiO₂ was formed. A 5 nm-thick non-granular magnetic recording layer was further formed as a second magnetic recording layer. A 10 nm-thick protective layer 7 of carbon was continuously formed by a sputtering film-forming method and a CVD method.

Thus, the raw material medium 10 was produced so that the soft magnetic layer 2, the crystal orientation control layer 3, the magnetic recording layer 4 composed of the first and second magnetic recording layers and the protective layer 7 were laminated on the substrate 1.

Then, a 50 nm-thick resist for electron beam (EB) drawing (e.g., ZEP-520A made by ZEON Corporation) was applied on the raw material medium 10 by a spin coater.

Then, a pattern was drawn on the resist by an EB apparatus.

Then, development with an EB resist developing solution (e.g., ZEP-RD made by ZEON Corporation) was performed by a coater developer apparatus to obtain patterning of the resist. In patterning of the resist, data regions and servo regions were drawn. Each data region was formed as a line and groove along the circumference of a circle in accordance with each sector. The width of the line and groove was set so that the resist remaining portion was 40 nm wide and the magnetic recording layer exposure portion was 60 nm wide. Each servo region was formed so that each island of burst was surrounded by a separation portion. With respect to burst of servo, the magnetic portion and the separation portion may be formed as reversed patterns because signal values “0” and “1” were only reversed.

Not only direct drawing based on EB drawing but also a nano-imprinting method in consideration of mass production can be used for patterning of the resist.

Then, patterning of the carbon protective film was performed. The carbon protective film was etched with an oxygen gas by a reactive ion etching (RIE) method while the resist was used as a mask. RIE was performed by a high density plasma etching apparatus using an Inductive Coupled Plasma (ICP) method. Plasma generating power of the high density plasma etching apparatus was set to be 300 W at 13.56 MHz, and bias power was set to be 10 W. The gas flow rate and the gas pressure were set to be 50 sccm and 0.1 Pa respectively. Alternatively, patterning of the carbon protective film can be performed by ion milling.

Then, the magnetic layer is etched by an ion milling method. Argon was used as ions in the ion milling method. The flow rate of the argon gas, the gas pressure and the acceleration voltage were set to be 10 sccm, 0.05 Pa and 500 V respectively, so that the magnetic layer was processed up to a depth of 15 nm.

Then, the remaining resist and the protective film were removed by ashing in oxygen plasma. A high density plasma etching apparatus using an ICP method was used while plasma generating power was set to be 200 W at 13.56 MHz and bias power was set to be 0 W. In addition, the gas flow rate and the gas pressure were set to be 50 sccm and 1 Pa, respectively. On this occasion, it is preferable that adjustment is made so that a protective film several nm thick remains on the magnetic layer surface of each track portion in order to suppress oxidation of the magnetic layer.

Then, the separation layer is formed by a sputtering method. The following material can be used as a target. In this example, a chromium alloy containing 15 atomic % of boron was used for forming a 100 nm-thick film under the conditions of argon gas flow rate of 50 sccm, gas pressure of 0.1 Pa and power of 400 W.

(1) A chromium alloy containing 10 atomic % to 20 atomic % of boron;

(2) A nickel alloy containing 12 atomic % to 22 atomic % of boron;

(3) A chromium alloy containing 8 atomic % to 18 atomic % of phosphorus; and

(4) A nickel alloy containing 14 atomic % to 24 atomic % of phosphorus.

Then, the surplus of the separation layer was etched up to the magnetic layer surface by an ion milling method. The flow rate of the argon gas, gas pressure and power were set to be 50 sccm, 5 Pa and 500 W, respectively. An end point monitor was used for performing processing up to the magnetic layer surface while carbon was used as a detection signal.

A 4 nm-thick protective layer 6 of carbon was further formed by a sputtering film-forming method and a CVD method.

When, for example, diamond-like carbon is used, the protective layer 6 can be formed by a chemical vapor deposition method or a physical vapor deposition method if necessary.

Then, a 2 nm-thick liquid lubricant layer of perfluoro polyether was formed by a dip method. Thus, a perpendicular magnetic recording medium was produced.

The surface roughness of the magnetic recording medium obtained thus was evaluated with an AFM. As a result, the surface roughness, Ra, (arithmetic average roughness) of each track portion was 0.4 nm, so that a smooth surface was secured. In addition, the surface roughness caused by patterns of the magnetic portion and the separation portion was 1.5 nm at maximum, that is, the surface roughness was smaller than 2 nm required of the magnetic recording medium based on stable floating of the head or the like. Further, head floating characteristic TOV (Take Off Velocity) and signal quality characteristic were good.

### Comparative Example

A magnetic recording medium was produced in the same manner as in the example except that Cr was used as a material of each separation portion.

The surface roughness of the magnetic recording medium obtained thus was evaluated with an AFM. As a result, the surface roughness, Ra, of each track portion was 1.7 nm. In addition, the surface roughness caused by patterns of the magnetic portion and the separation portion was 3 nm at maximum, that is, the surface roughness was larger than the 2 nm required for the magnetic recording medium based on stable floating of the head or the like. Further, TOV was worsened by 30% compared with the example.

As is apparent from the example and the comparative example, a patterned medium excellent in smoothness and good in head floating characteristic could be produced without spoiling basic characteristic of the magnetic recording medium when the material according to the invention was used for the separation layer.

The invention can be applied to a discrete track medium or a patterned medium as a high recording density perpendicular magnetic recording medium.

While the present invention has been described in conjunction with embodiments and variations thereof, one of ordinary skill, after reviewing the foregoing specification, will be able to effect various changes, substitutions of equivalents and other alterations without departing from the broad concepts disclosed herein. It is therefore intended that Letters Patent granted hereon be limited only by the definition contained in the appended claims and equivalents thereof.

What is claimed is:

1. A magnetic recording medium, comprising:
a substrate;
a magnetic recording layer that is provided on the substrate and that has a plurality of tracks; and
a separation layer that magnetically separates respective tracks of the plurality of tracks of the magnetic recording layer from one another and that is comprised of a nonmagnetic amorphous alloy selected from the group consisting of chromium boride (CrB), nickel boride (NiB), chromium phosphide (CrP), and nickel phosphide (NiP).

2. The magnetic recording medium according to claim 1, wherein the nonmagnetic amorphous alloy is chromium boride (CrB) containing 5 atomic % to 20 atomic % of boron (B).

3. The magnetic recording medium according to claim 1, wherein the nonmagnetic amorphous alloy is nickel boride (NiB) containing 12 atomic % to 22 atomic % of boron (B).

4. The magnetic recording medium according to claim 1, wherein the nonmagnetic amorphous alloy is chromium phosphide (CrP) containing 8 atomic % to 18 atomic % of phosphorus (P).

5. The magnetic recording medium according to claim 1, wherein the nonmagnetic amorphous alloy is nickel phosphide (NiP) containing 14 atomic % to 24 atomic % of phosphorus (P).

6. The magnetic recording medium according to claim 1, further comprising a protective layer provided on the magnetic recording layer.

7. The magnetic recording medium according to claim 1, wherein the separation layer consists essentially of the nonmagnetic amorphous alloy.

8. The magnetic recording medium according to claim 1, wherein the separation layer consists of the nonmagnetic amorphous alloy.
